(19) United States
(12) Patent Application Publication
(10) Pub. No.: US 2019/0270081 A1
(43) Pub. Date: Sep. 5, 2019

(54) CATALYTIC AND SORPTIVE ARTICLES COMPRISING METAL FIBER FELT SUBSTRATES

(71) Applicant: BASF Corporation, Florham Park, NJ (US)

(72) Inventors: Oleg Ilinich, Monmouth Junction, NJ (US); Stanley A. Roth, Yardley, PA (US); Jeffrey B. Hoke, North Brunswick, NJ (US)

(21) Appl. No.: 16/345,391

(22) PCT Filed: Oct. 27, 2017
(86) PCT No.: PCT/IB2017/056700

§ 371 Date: Apr. 26, 2019

Related U.S. Application Data
(60) Provisional application No. 62/414,186, filed on Oct. 28, 2016.

(51) Int. Cl. B01J 35/06; B01J 35/04; B01J 23/44; B01J 23/42; B01J 20/18; F01N 3/28; F01N 3/08

(52) U.S. Cl. CPC B01J 35/06; B01J 35/04; B01J 23/44; B01J 23/42; F01N 2330/10; F01N 3/2835; F01N 3/2807; F01N 3/0814; B01J 20/186

(57) ABSTRACT

Catalytic and/or sorptive articles comprising a metal fiber felt, the metal felt having an array of metal fibers and voids and a catalyst composition and/or a sorbent composition disposed on the metal fibers and within the voids are described. Such articles can be highly effective towards the abatement of pollutants in exhaust gas streams from internal combustion engines.

### FIELD OF THE INVENTION

The present invention relates to functional articles, such as catalytic and/or sorptive articles, for use in treating the exhaust of an internal combustion engine. The invention further relates to methods of making and using such functional articles and to exhaust gas treatment systems employing such articles.

### BACKGROUND OF THE INVENTION

Lean burn engines, for example diesel engines, provide the user with excellent fuel economy due to their operation at high air/fuel ratios under fuel lean conditions. However, diesel engines lead to exhaust gas emissions containing particulate matter (PM), unburned hydrocarbons (HC), carbon monoxide (CO), and nitrogen oxides (NOx), wherein NOx describes various chemical species of nitrogen oxides, including nitrogen monoxide and nitrogen dioxide, among others. The two major components of exhaust particulate matter are the soluble organic fraction (SOF) and the soot fraction. The SOF condenses on the soot in layers and is generally derived from unburned diesel fuel and lubricating oils. The SOF can exist in diesel exhaust either as a vapor or as an aerosol (i.e., fine droplets of liquid condensate), depending on the temperature of the exhaust gas. Soot is predominately composed of particles of carbon.

Oxidation catalysts comprising a precious metal, such as platinum group metals (PGMs), dispersed on a refractory metal oxide support, such as alumina, are known for use in treating the exhaust of diesel engines in order to convert both hydrocarbon and carbon monoxide gaseous pollutants by catalyzing the oxidation of these pollutants to carbon dioxide and water. Such catalysts have been generally contained in units called diesel oxidation catalysts (DOC), which are placed in the exhaust flow path from diesel power systems to treat the exhaust before it vents to the atmosphere. Typically, such diesel oxidation catalysts are formed on ceramic or metallic substrates upon which one or more catalyst coating compositions are deposited. In addition to the conversion of gaseous HC and CO emissions and particulate matter (SOF portion), oxidation catalysts that contain PGM promote the oxidation of NO to NO₂. Catalysts are typically defined by their light-off temperature or the temperature at which 50% conversion is attained, also called T₅₀.

Platinum (Pt) remains the most effective platinum group metal for oxidizing CO and HC in a DOC in the presence of sulfur. After high temperature aging under lean conditions, there can be an advantage to adding Pd to a Pt-based DOC, because Pd stabilizes Pt against sintering at the high temperature. One of the major advantages of using palladium (Pd) based catalysts is the lower cost of Pd compared to Pt. However, Pd-based DOCs, without Pt, typically show higher light-off temperatures for oxidation of CO and HC, especially when used with HC storage materials, potentially causing a delay in HC and or CO light-off. For this reason care, must be taken to design the catalyst to maximize positive interactions while minimizing negative interactions.

Catalysts used to treat the exhaust of internal combustion engines are less effective during periods of relatively low temperature operation, such as the initial cold-start period of engine operation, because the engine exhaust is not at a temperature sufficiently high for efficient catalytic conversion of noxious components in the exhaust gas. To this end, it is known in the art to include an adsorbent material, which may be a zeolite, as part of a catalytic treatment system in order to adsorb gaseous pollutants, usually hydrocarbons, and retain them during the initial cold-start period. As the exhaust gas temperature increases, the adsorbed hydrocarbons are driven from the adsorbent and subjected to catalytic treatment at the higher temperature.

One effective method to reduce NOₓ from the exhaust of lean-burn engines, such as gasoline direct injection and partial lean-burn engines, as well as from diesel engines, requires trapping and storing of NOₓ under lean burn engine operating conditions and reducing the trapped NOₓ under stoichiometric or rich engine operating conditions or under lean engine operation with external fuel injected in the exhaust to induce rich conditions. The lean operating cycle is typically between 1 minute and 20 minutes and the rich operating cycle is typically short (1 to 10 seconds) to preserve as much fuel as possible. To enhance NOₓ conversion efficiency, short and frequent regeneration is favored over long but less frequent regeneration. Thus, a lean NOₓ trap catalyst generally must provide a NOₓ trapping function and a three-way conversion function.

Some lean NOₓ trap (LNT) systems contain alkaline earth elements. For example, NOₓ sorbent components include alkaline earth metal oxides, such as oxides of Mg, Ca, Sr or Ba. Other lean LNT systems can contain rare earth metal oxides such as oxides of Ce, La, Pr or Nd. The NOₓ sorbents can be used in combination with platinum group metal catalysts such as platinum dispersed on an alumina support for catalytic NOₓ oxidation and reduction. The LNT catalyst operates under cyclic lean (trapping mode) and rich (regeneration mode) exhaust conditions during which the engine out NO is converted to N₂.

Another effective method to reduce NOₓ from the exhaust of lean-burn engines requires reaction of NOₓ under lean burn engine operating conditions with a suitable reductant such as ammonia or hydrocarbon in the presence of a selective catalytic reduction (SCR) catalyst. Suitable SCR catalysts include metal-containing molecular sieves such as metal-containing zeolites. A useful SCR catalyst component is able to effectively catalyze the reduction of the NOx exhaust component at temperatures below 600° C., so that reduced NOx levels can be achieved even under conditions of low load which typically are associated with lower exhaust temperatures.

These observations, in conjunction with emissions regulations becoming more stringent, have driven the need for developing emission gas treatment systems with improved CO, HC and NO oxidation capacity to manage CO, HC and NO emissions at low engine exhaust temperatures. In addition, development of emission gas treatment systems for the reduction of NOₓ (NO and NO₂) emissions to nitrogen has become increasingly important.

### SUMMARY OF THE INVENTION

The present disclosure describes a functional article comprising a metal fiber felt, the metal felt having an array of metal fibers and voids and a catalyst composition and/or a sorbent composition disposed on the metal fibers and within the voids. Also disclosed is an exhaust gas treatment system comprising a functional article comprising a metal fiber felt, the metal felt having an array of metal fibers and voids and a catalyst composition and/or a sorbent composition disposed on the metal fibers and within the voids. Also disclosed is a method for treating an exhaust gas stream, comprising passing the exhaust stream through an article or a system as described herein.

In one aspect, the disclosure provides a functional article comprising: a metal fiber felt, the metal fiber felt having an array of metal fibers and voids; and a functional composition, comprising a catalyst composition, a sorbent composition, or both a catalyst composition and a sorbent composition disposed on the metal fibers and within the voids. In some specific embodiments, the functional composition comprises a catalyst composition. In some specific embodiments, the functional composition comprises a sorbent composition. In some specific embodiments, the functional composition comprises both a catalyst composition and a sorbent composition. The functional article can be, for example, a flow-through catalyst.

The metal fiber felt of the disclosed functional article can, in some embodiments, be woven, or can be non-woven. In some embodiments, the metal fiber felt is flat and, in some embodiments, the metal fiber felt is corrugated.

In some embodiments, the functional article comprises a three-dimensional matrix comprising a plurality of metal fiber felt layers. The three-dimensional matrix, for example, can comprise both corrugated layers of the metal fiber felt and flat layers of the metal fiber felt. The three-dimensional matrix, in some embodiments, comprises corrugated layers of the metal fiber felt and flat layers of a metal foil. In further embodiments, the three-dimensional matrix comprises corrugated layers of a metal foil and flat layers of the metal fiber felt. In some embodiments, the metal felt comprises the functional composition as a coating within the voids thereof. In some embodiments, the metal foil comprises the functional composition as a coating thereon. The functional article can, in certain embodiments, further comprise a metal jacket with the three-dimensional matrix in an interior portion thereof.

In some embodiments, the metal fiber felt comprises stainless steel, nickel, a NiCr alloy or a FeCr alloy. For example, in specific embodiments, the metal fiber felt comprises a FeCrAl alloy. The void volume of the disclosed functional articles can be, for example, from about 20% to about 95%, based on the total volume of the metal felt. In some embodiments, the functional composition occupies from about 5% to about 100% of an original void volume of the metal fiber felt substrate that exists before coating with the functional composition. In some embodiments, the metal fiber felt is from about 20 μm to about 12,000 μm thick on average. In some embodiments, the metal fiber felt contains metal fibers having an average diameter of from about 1 μm to about 250 μm. In some embodiments, the functional composition comprises from about 2% to about 80% of the total weight of the metal felt plus the functional composition.

In various embodiments, a functional article is provided wherein the catalyst composition comprises a noble metal. For example, in some embodiments, the catalyst composition comprises a platinum group metal. In certain embodiments, the catalyst composition comprises platinum, palladium, or a combination thereof. In certain embodiments, the catalyst composition comprises rhodium. In other embodiments, the catalyst composition is substantially free (e.g., free) of platinum group metals. The catalyst composition, in certain embodiments, comprises a base metal. The catalyst composition, in some embodiments, comprises a molecular sieve (e.g., zeolite) containing iron, copper, or a combination thereof.

Various types of catalyst and/or sorbent compositions can be associated with the functional article disclosed herein. For example, in some embodiments, the catalyst composition comprises a DOC (diesel oxidation catalyst), an LNT (lean NOx trap), a TWC (three-way catalyst), an AMOx (ammonia oxidation) catalyst, an SCR (selective catalytic reduction) catalyst, or any combination thereof. In certain embodiments, the catalyst composition comprises a refractory metal oxide support selected from alumina, silica, zirconia, titania, lanthana, ceria, praseodymia, neodymia, samaria, gadolinia, terbia, tin oxide, physical mixtures thereof and chemical combinations thereof. In some embodiments, the catalyst composition and/or the sorbent composition comprises alkaline earth metal oxides, alkaline earth metal carbonates, rare earth oxides or molecular sieves (e.g., zeolites).

The disclosure provides, in another aspect, an exhaust gas treatment system for an internal combustion engine comprising a functional article as disclosed herein. Such system can, in some embodiments, further comprise a soot filter. The functional article can be, for example, a diesel oxidation catalyst or a selective reduction catalyst. The functional article can be, for example, a lean NOx trap or a three-way catalyst. Further, the functional article can be, for example, an ammonia oxidation catalyst. In some embodiments, the functional article is downstream of and in fluid communication with an internal combustion engine.

In a further aspect, the disclosure provides a method for treating an exhaust gas stream, comprising passing the exhaust gas stream through a functional article as disclosed herein.

In a still further aspect, the disclosure provides a system comprising a functional article as disclosed herein for the removal of noxious or toxic substances from indoor air, for treatment of emissions from stationary industrial processes, or for catalysis in chemical reaction processes.

The present disclosure includes, without limitation, the following embodiments.
Embodiment 1: A functional article comprising: a metal fiber felt, the metal fiber felt having an array of metal fibers and voids; and a functional composition, comprising a catalyst composition, a sorbent composition, or both a catalyst composition and a sorbent composition disposed on the metal fibers and within the voids.
Embodiment 2: The functional article of any preceding embodiment, wherein the functional composition comprises a catalyst composition.
Embodiment 3: The functional article of any preceding embodiment, wherein the functional composition comprises a sorbent composition.
Embodiment 4: The functional article of any preceding embodiment, wherein the metal fiber felt is woven.
Embodiment 5: The functional article of any preceding embodiment, wherein the metal fiber felt is non-woven.
Embodiment 6: The functional article of any preceding embodiment, wherein the metal fiber felt is flat.
Embodiment 7: The functional article of any preceding embodiment, wherein the metal felt is corrugated.
Embodiment 8: The functional article of any preceding embodiment, comprising a three-dimensional matrix comprising a plurality of metal fiber felt layers.
Embodiment 9: The functional article of any preceding embodiment, wherein the three-dimensional matrix comprises both corrugated layers of the metal fiber felt and flat layers of the metal fiber felt.
Embodiment 10: The functional article of any preceding embodiment, wherein the three-dimensional matrix comprises corrugated layers of the metal fiber felt and flat layers of a metal foil.
Embodiment 11: The functional article of any preceding embodiment, wherein the three-dimensional matrix comprises corrugated layers of a metal foil and flat layers of the metal fiber felt.
Embodiment 12: The functional article of any preceding embodiment, wherein the metal fiber felt comprises the functional composition as a coating within the voids.
Embodiment 13: The functional article of any preceding embodiment, wherein the metal foil comprises the functional composition as a coating thereon.
Embodiment 14: The functional article of any preceding embodiment, further comprising a metal jacket with the three-dimensional matrix in an interior portion thereof.
Embodiment 15: The functional article of any preceding embodiment, wherein the metal fiber felt comprises stainless steel, nickel, a NiCr alloy or a FeCr alloy.
Embodiment 16: The functional article of any preceding embodiment, wherein the metal fiber felt comprises a FeCrAl alloy.
Embodiment 17: The functional article of any preceding embodiment, wherein the metal fiber felt has a void volume of from about 20% to about 95% or about 60% to about 90%, based on the total volume of the metal felt.
Embodiment 18: The functional article of any preceding embodiment, wherein the functional composition occupies from about 5% to about 100% or about 30% to about 100% of an original void volume of the metal fiber felt substrate that exists before coating with the functional composition.
Embodiment 19: The functional article of any preceding embodiment, wherein the metal fiber felt is from about 50 μm to about 12,000 μm or about 100 μm to about 500 μm thick on average.
Embodiment 20: The functional article of any preceding embodiment, wherein the metal fiber felt contains metal fibers having an average diameter of from about 1 μm to about 250 μm or about 10 μm to about 100 μm.
Embodiment 21: The functional article of any preceding embodiment, wherein the functional composition comprises from about 2% to about 80% or about 20% to about 60% of the total weight of the metal felt plus the functional composition.
Embodiment 22: The functional article of any preceding embodiment, wherein the catalyst composition comprises a platinum group metal or a base metal.
Embodiment 23: The functional article of any preceding embodiment, wherein the catalyst composition comprises a DOC (diesel oxidation catalyst), a LNT (lean NOx trap), a TWC (three-way catalyst), an AMOx (ammonia oxidation) catalyst, an SCR (selective catalytic reduction) catalyst, or any combination thereof.
Embodiment 24: An exhaust gas treatment system comprising the functional article of any preceding embodiment.
Embodiment 25: A method for treating an exhaust gas stream, comprising passing the exhaust gas stream through the functional article of any preceding embodiment.
Embodiment 26: A system comprising the functional article of any preceding embodiment for the removal of noxious or toxic substances from indoor air, for treatment of emissions from stationary industrial processes, or for catalysis in chemical reaction processes.

These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise. Other aspects and advantages of the present invention will become apparent from the following.

### BRIEF DESCRIPTION OF THE FIGURES

In order to provide an understanding of embodiments of the invention, reference is made to the appended drawings, which are not necessarily drawn to scale, and in which reference numerals refer to components of exemplary embodiments of the invention. The drawings are exemplary only, and should not be construed as limiting the invention.

FIG. 1 is a micrograph of a metal fiber felt comprising a random array of intertwined Fecralloy® fibers about 20 μm in diameter;

FIGS. 2A-2D show some possible shapes of corrugation for metal fiber felts;

FIG. 3 shows an article containing a coiled corrugated metal fiber felt of Fecralloy® and flat secluding foils of Fecralloy®, with a diameter of 5.66 inches, a length of 3 inches, and a nominal channel density of 400 cpsi (cells per square inch);

FIG. 4 shows another article containing a coiled metal fiber felt of Fecralloy®, with 250 μm thick felt (both corrugated and flat), comprising fibers from about 20 μm in diameter and having about 80% void volume;

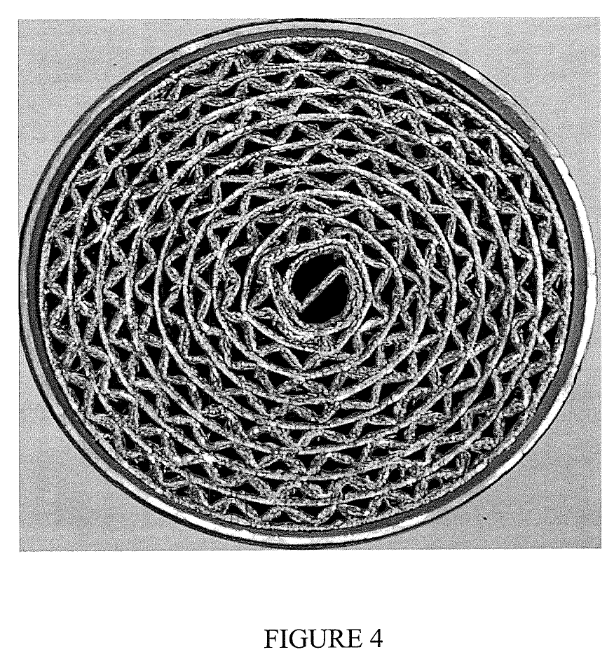

FIG. 5 shows an inventive catalyst article comprising the fibrous metal felt substrate coated with a catalyst washcoat composition (Example 2);

FIG. 6 shows catalytic performance data in a laboratory transient catalytic performance test modeled after the standard NEDC certification drive cycle for a DOC catalyst of identical composition on a Fecralloy® substrate (inventive) and a commercial cordierite honeycomb substrate (comparative) (Example 3);

FIG. 7 provides a graph of tailpipe CO emissions in a laboratory transient catalytic performance test for the DOC catalyst on the Fechraloy® felt and commercial cordierite honeycomb substrates;

FIG. 8 is a graph providing laboratory test data on NO conversion at 175-300° C. with SCR catalysts of identical composition coated on Fechraloy® felt and commercial cordierite honeycomb substrates (under test conditions: 500 ppm NO, 500 ppm NH₃, 5% H₂O, 10% O₂, balance N₂; GHSV=80 000 h⁻¹);

FIG. 9 is a graph providing laboratory test data on NO conversion at 200° C. and 250° C. with LNT catalysts of identical composition coated on Fechraloy® felt and commercial cordierite honeycomb substrates; and

FIG. 10 shows back-pressure (pressure drop) results for an inventive article vs. a comparative article both coated at 4.3 g/in³ on 400 cpsi substrates that are 5.66 inch in diameter by 3 inch long (Example 6).

### DETAILED DESCRIPTION OF THE INVENTION

The present invention provides emission treatment articles, systems and methods for at least partial conversion of gaseous CO, HC and NOx emissions. The emission treatment article comprises a monolithic structure further comprising a metal fiber felt useful as a carrier for catalytic and/or sorptive materials (referred to herein generally as “functional materials”). The metal fiber felt having a catalyst composition and/or a sorbent composition (i.e., a functional material) within the voids thereof may be termed a catalytic and/or sorptive metal fiber felt or a catalyst-loaded and/or sorbent-loaded metal fiber felt.

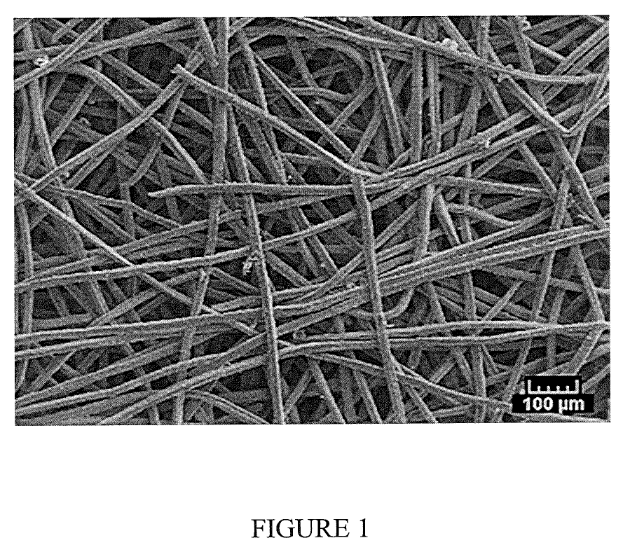

The metal fiber felt of the present invention comprises woven or non-woven metal fibers or filaments. The fibers or filaments are for example from about 1 μm, about 2 μm, about 3 μm, about 4 μm, about 5 μm, about 6 μm, about 7 μm, about 8 μm, about 9 μm or about 10 μm to about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 30 μm, about 35 μm, about 40 μm, about 45 μm, about 50 μm, about 60 μm, about 70 μm, about 80 μm, about 90 μm, about 100 μm, about 120 μm, about 130 μm or about 150 μm in diameter, on average. A metal fiber felt comprising intertwined Fecralloy® fibers that are about 20 microns in diameter is shown in FIG. 1. The fibers of the metal fiber felt may, in some embodiments, be uniform, having essentially the same diameter or alternatively, may have a range of varying sizes, lengths and shapes.

The metal fiber felt useful in the present invention may comprise an intertwined random array of non-woven fibers or filaments. A suitable metal fiber felt may be from about 20 μm, 50 μm, about 75 μm, about 100 μm, about 125 μm, about 150 μm, about 175 μm, about 200 μm or about 225 μm to about 250 μm, about 275 μm, about 300 μm, about 325 μm, about 350 μm, about 375 μm, about 400 μm, about 425 μm, about 450 μm, about 475 μm or about 500 μm thick on average. The metal fiber felt may alternatively be much thicker, for instance from about 200 μm to about 2 inches (50,800 μm) or from about 200 μm to about 1 inch (25,400 μm), for example from about 300 μm to about 20,000 μm, from about 400 μm to about 18,000 μm, from about 500 μm to about 15,000 μm or from about 600 μm to about 12,000 μm thick on average.

It is not critical by what process the metal fiber felts are prepared. Metal fiber felts are prepared, for example, by a process comprising sintering metal fibers under compression. Such methods are taught, for example, in U.S. Pat. Appl. Publ. No. 2011/0209451 to Kotthoff et al., which is incorporated herein by reference.

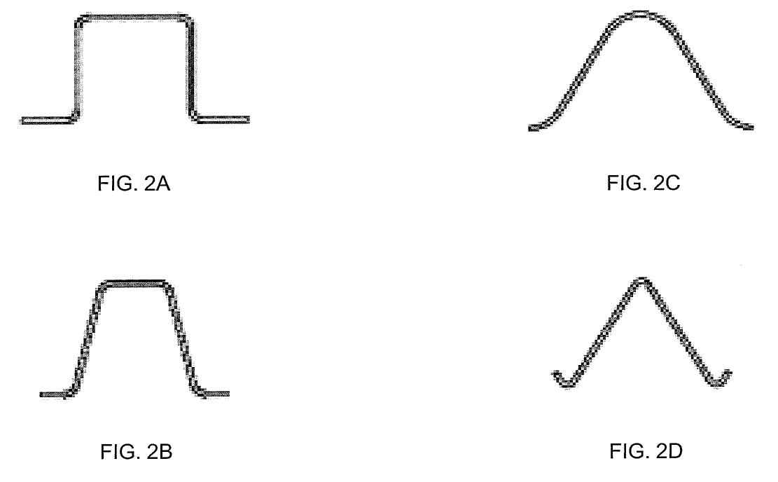

The metal fiber felt is highly porous and thereby exhibits a high degree of void volume (voids) or “empty space” throughout its thickness. For instance, the void volume of the metal fiber felt is from about 20%, about 25%, about 30%, about 35%, about 40%, about 45%, about 50% or about 55% to about 60%, about 65%, about 70%, about 75%, about 80%, about 85%, about 90% or about 95% of the total volume of the metal felt, on average prior to being treated/loaded with a catalyst and/or sorbent composition. In some embodiments, the void volume can be about 20% to about 95% or about 50% to about 95% of the total volume of the metal felt, on average prior to being treated/loaded with a catalyst and/or sorbent composition. The metal fiber felt may be flat, without any applied surface structure. Alternatively, the metal fiber felt may advantageously be corrugated. Corrugation may be accomplished with traditional means/equipment. Various non-limiting corrugation shapes are shown in FIGS. 2a-2d.

The metal fiber felt can be stacked, coiled, wound or folded, providing a three dimensional structure with a plurality of metal fiber layers. In addition, the stacked, coiled, wound or folded metal fiber felt having corrugation will provide a three dimensional structure with a plurality of metal fiber layers and a plurality of channels (gas flow passages) extending there through from an inlet to an outlet face of the structure such that passages are open to fluid flow there through. The channel walls comprising the fiber felt provide high geometric surface area for flowing gas to contact catalytic and/or adsorptive materials deposited thereon. Even without corrugation, the porosity of the metal fiber felt will create a plurality of random and tortuous gas flow passages from the inlet face to the outlet face of the three dimensional structure on which functional catalytic and/or adsorptive compositions can be deposited. Corrugated layers may also be separated by flat layers in-between referred to as secluding layers. The three dimensional structure comprising the metal fiber felt can also be referred to as a metal fiber felt substrate.

The catalyst and/or sorbent articles comprising the metal fiber felt substrate have an inlet end, an outlet end, an axial length and an axial width. The inlet end of an article is synonymous with the “upstream” end or “front” end. The outlet end is synonymous with the “downstream” end or “rear” end. The upstream end is towards the source of exhaust gas, for example an internal combustion engine.

In the present articles, both the corrugated layers and secluding layers may comprise the metal fiber felt. Alternatively, the corrugated layers may comprise the metal fiber felt and the secluding layers may comprise metal foils; or the corrugated layers may comprise metal foils and the secluding layers may comprise the metal fiber felt.

Secluding foils are for example flat foils, flat foils with etch-holes or micro-ripple foils commonly known in the art. Secluding foils are an additional supporting foil between corrugated metal layers, for example corrugated metal fiber felt layers. Flat secluding foils have a thickness, for example, from about 10 μm to about 150 μm or from about 25 μm to about 125 μm, for example from about 40 μm to about 95 μm.

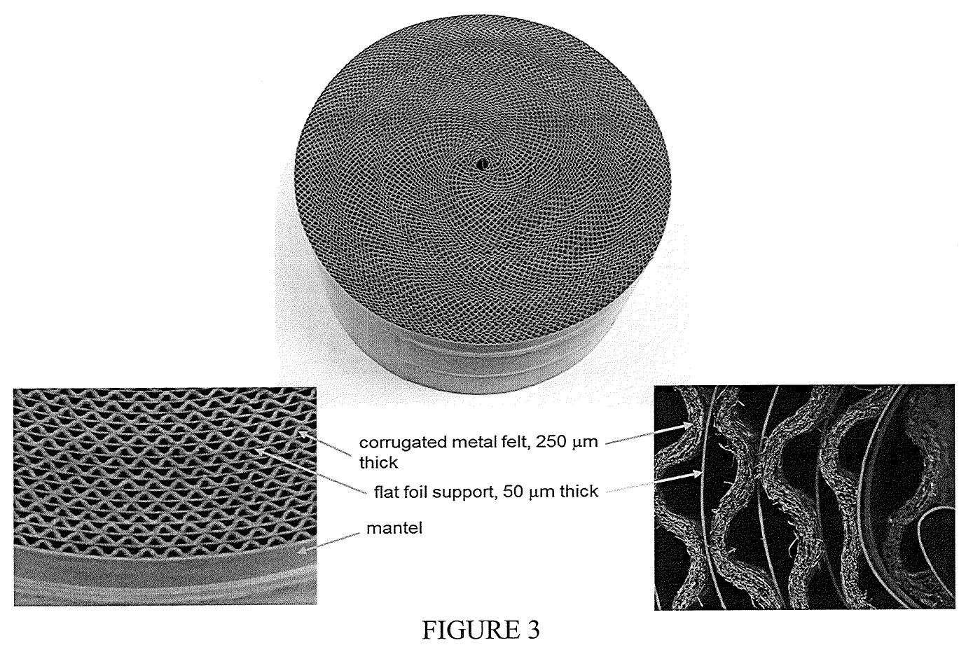

The above stacked, coiled, wound or folded compositions comprising a plurality of metal felt layers provide a stacked, coiled, wound or folded matrix having a three dimensional structure. The matrix may be inserted into a metal jacket or mantle and the periphery of the matrix may be joined to the mantle interior. The metal layers may be fused together by brazing. Such a monolith article (metal fiber felt substrate) is shown in FIG. 3. The channel openings are clearly visible.

Depending on the processing conditions of corrugation, the channels formed by the stacked, coiled wound or folded compositions can have various sizes or shapes such as trapezoidal, rectangular, square, sinusoidal, hexagonal, etc. Typically, the articles of the present invention have a cell (channel) density of from about 60 cells per square inch (cpsi) of cross sectional area perpendicular to the gas flow to about 500 cpsi or up to about 900 cpsi, for example from about 200 to about 400 cpsi.

The metal of the metal fiber felt is an elemental metal or a metal alloy, for example Ni, a NiCr alloy, stainless steel or an FeCr alloy. A suitable and commercially available stainless steel metal alloy is identified as Haynes 214 alloy. This alloy and other useful nickeliferous alloys are described for example in U.S. Pat. No. 4,671,931 to Herchenroeder et al., which is incorporated herein by reference. These alloys are characterized by high resistance to oxidation and high temperatures. A specific example contains about 75% nickel, about 16% chromium, about 4.5% aluminum, about 3% iron, optionally trace amounts of one or more rare earth metals except yttrium, about 0.05% carbon and steel making impurities, by weight. Haynes 230 alloy, also useful herein, has a composition containing about 22% chromium, about 14% tungsten, about 2% molybdenum, about 0.10% carbon, a trace amount of lanthanum, balance nickel, by weight.

Suitable alloys also include those in which iron is a substantial or major component, for example FeCr alloys and ferritic stainless steels. FeCr alloys may contain one or more of nickel, chromium, and aluminum, and the total of these metals may advantageously comprise at least about 15 wt. % (weight percent) of the alloy, for instance, about 10 to about 25 wt. % chromium, about 1 to about 8 wt. % of aluminum, and from 0 to about 20 wt. % of nickel, balance iron. FeCr alloys include FeCrAl alloys, which contain, for example, from about 10 to about 25 wt. % chromium, from about 3 to about 8 wt. % aluminum, optional trace amounts of a rare earth metal and/or another transition metal and balance iron. A suitable FeCrAl alloy is Fecralloy®, an alloy, by weight, of Fe 72.8/Cr 22/Al 5/Y 0.1/Zr 0.1.

Also suitable is “ferritic” stainless steel such as that described in U.S. Pat. No. 4,414,023. An example of a suitable ferritic stainless steel alloy contains about 20% chromium, about 5% aluminum and from about 0.002% to about 0.05% of at least one rare earth metal selected from cerium, lanthanum, neodymium, yttrium and praseodymium or a mixture of two or more of such rare earth metals, balance iron and trace steel making impurities, by weight.

The ferritic stainless steels and the Haynes alloys 214 and 230, all of which are considered to be stainless steels, are examples of high temperature resistive, oxidation resistant (or corrosion resistant) metal alloys that are useful in the present invention. Suitable metal alloys for use in this invention should, for example, be able to withstand “high” temperatures, e.g., from about 500° C. to about 1200° C. (about 932° F. to about 2012° F.) over prolonged periods. Other high temperature resistive, oxidation resistant metal alloys are known and may be suitable.

The catalyst and/or sorbent composition is disposed on the metal fibers and is in adherence thereto. The catalyst and/or sorbent composition is also within the voids of the porous metal fiber felt (occupies the voids). The catalyst and/or sorbent composition within the voids is in adherence to the metal fibers or filaments. The catalyst and/or sorbent composition may be disposed on metal fibers towards the interior of the felt and/or on metal fibers at the felt surface. Thus, the catalyst and/or sorbent composition may be distributed throughout the interior of the fiber felt and may also be disposed on the surface of the fiber felt.

A catalyst and/or sorbent composition may comprise one or more supports (refractory inorganic solid oxide porous powders) further comprising functional active species. A catalyst composition may typically be applied in the form of a washcoat containing supports having catalytically active species thereon. A sorbent composition may typically be applied in the form of a washcoat containing sorption active species. A washcoat is formed by preparing a slurry containing a specified solids content (e.g., about 10 to about 60% by weight) of support having catalytically active species thereon or of sorbent materials in a liquid vehicle, which is then applied to a metal fiber felt substrate and dried and calcined to provide a coating layer. If multiple coating layers are applied, the substrate is dried and optionally calcined after each layer is applied and/or after the number of desired multiple layers are applied.

The metal fiber felt substrate may advantageously be treated at high temperature prior to coating with a catalyst and/or sorbent composition (functional composition). This may aid in adhering the functional composition to the fibers.

Catalyst and/or sorbent compositions may be prepared using a binder, for example, a ZrO₂ binder derived from a suitable precursor such as zirconyl acetate or any other suitable zirconium precursor such as zirconyl nitrate. A zirconyl acetate binder provides a coating that remains homogeneous and intact after thermal aging, for example, when the catalyst is exposed to high temperatures of at least about 600° C., for example, about 800° C. and higher, and high water vapor environments of about 5% or more. Other potentially suitable binders include, but are not limited to, alumina and silica. Alumina binders include aluminum oxides, aluminum hydroxides, and aluminum oxyhydroxides. Aluminum salts and colloidal forms of alumina many also be used. Silica binders include various forms of SiO₂, including silicates and colloidal silica. Binder compositions may include any combination of zirconia, alumina, and silica.

A catalyst and/or sorbent composition may also be applied separately to the metal felts and metal foils of the present articles prior to stacking, coiling, winding or folding into a three dimensional structure. The catalyst and/or sorbent composition deposited on the metal foil may be the same or different than that disposed within the metal fiber felt. The catalyst and/or sorbent compositions present in metal felt voids, on a metal felt surface or on a metal foil surface may be referred to herein as “functional coatings,” and more specifically, as “catalytic coatings” or “sorbent coatings.”

The present catalyst and/or sorbent coatings are present on/in the metal fiber felts at a loading (concentration) of, for instance, from about 0.2 g/in³ to about 8.0 g/in³ based on the metal fiber felt substrate volume; or from about 0.3 g/in³ to about 7.0 g/in³; from about 0.4 g/in³, about 0.5 g/in³, about 0.6 g/in³, about 0.7 g/in³, about 0.8 g/in³, about 0.9 g/in³ or about 1.0 g/in³ to about 1.5 g/in³, about 2.0 g/in³, about 2.5 g/in³, about 3.0 g/in³, about 3.5 g/in³, about 4.0 g/in³, about 4.5 g/in³, about 5.0 g/in³, about 5.5 g/in³, about 6.0 g/in³, about 6.5 g/in³, about 7.0 g/in³ or about 7.5 g/in³ or about 8 g/in³. These values refer to dry solids weight per volume of substrate.

The high void volume of the metal fiber felt allows for high loading of functional compositions. This is a particular advantage for applications that require a high loading of catalytic or adsorptive species in order to maximize functional performance. For example, the functional composition may comprise up to about 50% or up to about 80% of the total weight (functional composition and metal felt). For example the functional composition may comprise from about 2%, about 5%, about 10%, about 15%, about 20% or about 25% to about 30%, about 40%, about 45% about 50%, about 55%, about 60%, about 65%, about 70%, about 75%, about 80%, about 85%, or about 90% of the total weight of the metal felt plus functional composition.

The present functional articles may be, for example, flow-through articles where exhaust gas flow enters the inlet end of the three dimensional metal fiber felt structure and exits the opposite outlet end after passing through the plurality of gas flow channels extending from the inlet end to the outlet end. At certain high functional composition loadings, the channel walls comprising the metal fiber felt are effectively completely filled/plugged with the functional composition, so that no flow of gases through the walls is possible except via diffusion. The present functional catalyst and/or sorbent compositions can occupy from about 5%, about 10%, about 20%, about 30%, about 40% or about 50% to about 60%, about 70%, about 80%, about 95% or about 100% of the original void volume of the metal fiber felt substrate that exists before coating with the functional composition.

Unlike a conventional ceramic or metal foil substrates where a functional composition is contacted by exhaust gas from only one side due to the presence of the impermeable substrate wall, the porous wall of the coated metal fiber felt substrate of the present invention allows contact of the functional composition with exhaust gases from both sides of the felt. This enables utilization of thicker coatings and minimizes diffusion limitations of the functional performance, particularly if less than 100% of the metal felt void volume is occupied by the function catalytic and/or adsorptive composition.

Among others, the functional catalyst composition may comprise a diesel oxidation catalyst (DOC), a lean NOx trap (LNT), a three-way conversion catalyst (TWC), an ammonia oxidation catalyst (AMOx), a selective catalytic reduction (SCR) catalyst, or a combination of two or more such catalysts. Catalyst compositions may, for example, comprise a catalytically active metal deposited on a refractory support material. The catalytically active metal is a base metal such as Fe, Cu, Mn or Co; a noble metal, for example a platinum group metal (PGM), or any combination of these metals. For example, certain catalyst compositions of the present invention useful for treating gaseous pollutants comprise a PGM, for instance platinum, palladium, or rhodium on support particles. A platinum group metal component may comprise a mixture of platinum and palladium, e.g., at a weight ratio of from about 1:10 to about 10:1, for example from about 1:5 to about 5:1. The active metals may be present as elemental metal or as a metal compound, typically an oxide compound.

The support material on which the catalytically active metal is deposited, for example, comprises a refractory metal oxide, which exhibits chemical and physical stability at high temperatures, such as the temperatures associated with gasoline or diesel engine exhaust. Exemplary metal oxides include alumina, silica, zirconia, titania, lanthana, ceria, praseodymia, neodymia, samaria, gadolinia, terbia, tin oxide, and the like, as well as physical mixtures or chemical combinations thereof, including atomically-doped combinations and including high surface area or activated compounds such as activated alumina. Included are combinations of metal oxides such as silica-alumina, ceria-zirconia, praseodymia-ceria, alumina-zirconia, alumina-ceria-zirconia, lanthana-alumina, lanthana-zirconia-alumina, baria-alumina, baria-lanthana-alumina, baria-lanthana-neodymia-alumina and alumina-ceria. Exemplary aluminas include large pore boehmite, gamma-alumina, and delta/theta alumina. Useful commercial aluminas used as starting materials in exemplary processes include activated aluminas, such as high bulk density gamma-alumina, low or medium bulk density large pore gamma-alumina and low bulk density large pore boehmite and gamma-alumina.

High surface area metal oxide supports, such as alumina support materials, also referred to as “gamma alumina” or “activated alumina,” typically exhibit a BET surface area in excess of 60 m²/g, often up to about 200 m²/g or higher. An exemplary refractory metal oxide comprises high surface area γ-alumina having a specific surface area of about 50 to about 350 m²/g. Such activated alumina is usually a mixture of the gamma and delta phases of alumina, but may also contain substantial amounts of eta, kappa and theta alumina phases. “BET surface area” has its usual meaning of referring to the Brunauer, Emmett, Teller method for determining surface area by N₂ adsorption. Desirably, the active alumina has a specific surface area of about 50 to about 350 m²/g, for example from about 75 to about 250 m²/g.

In certain embodiments, metal oxide supports useful in the catalyst compositions disclosed herein are doped alumina materials, such as Si-doped alumina materials (including, but not limited to 1-10% SiO₂—Al₂O₃), doped titania materials, such as Si-doped titania materials (including, but not limited to 1-10% SiO₂—TiO₂), or doped zirconia materials, such as Si-doped ZrO₂ (including, but not limited to 5-30% SiO₂—ZrO₂). Advantageously, a refractory metal oxide may be doped with one or more additional base metal oxide materials such as lanthanum oxide, cerium oxide, zirconium oxide, barium oxide, strontium oxide, calcium oxide, magnesium oxide, manganese oxide, copper oxide, iron oxide, or combinations thereof. The metal oxide dopant is typically present in an amount of about 1 to about 20% by weight, based on the weight of the catalyst composition. The dopant oxide materials may serve to improve the high temperature stability of the refractory metal oxide support or function as an adsorbent for acidic gases such as NO₂, SO₂ or SO₃. The dopant metal oxides can be introduced using an incipient wetness impregnation technique or by addition of colloidal mixed oxide particles. Preferred doped metal oxides include baria-alumina, baria-zirconia, baria-titania, baria-zirconia- alumina, lanthana-zirconia, lanthana-alumina, zirconia-alumina, and the like.

Thus, the refractory metal oxides or refractory mixed metal oxides in the catalyst composition are typically selected from the group consisting of alumina, zirconia, silica, titania, ceria, for example bulk ceria, manganese oxide, zirconia-alumina, ceria-zirconia, ceria-alumina, lanthana-alumina, silica, silica-alumina and combinations thereof. Further doping with base metal oxides provides additional useful refractory oxide supports including but not limited to baria-alumina, baria-zirconia, baria-titania, baria-zirconia-alumina, lanthana-zirconia, lanthana-alumina, zirconia-alumina, and the like.

The catalyst composition may comprise any of the above named refractory metal oxides and in any amount. For example, refractory metal oxides in the catalyst composition may comprise at least about 15, at least about 20, at least about 25, at least about 30 or at least about 35 wt. % (weight percent) alumina where the wt. % is based on the total dry weight of the catalyst composition. The catalyst composition may, for example, comprise from about 10 to about 99 wt. % alumina, from about 15 to about 95 wt. % alumina or from about 20 to about 85 wt. % alumina. The catalyst composition comprises for example from about 15 wt. %, about 20 wt. %, about 25 wt. %, about 30 wt. % or about 35 wt. % to about 50 wt. %, about 55 wt. %, about 60 wt. % about 65 wt. % or about 70 wt. % alumina based on the weight of the catalytic composition. Advantageously, in some embodiments, the support material of the catalyst composition may comprise ceria, alumina and zirconia or doped compositions thereof.

The noble metal is, for example, present in the catalyst composition from about 0.1 wt. %, about 0.5 wt. %, about 1.0 wt. %, about 1.5 wt. % or about 2.0 wt. % to about 3 wt. %, about 5 wt. %, about 7 wt. %, about 9 wt. %, about 10 wt. %, about 12 wt. %, about 15 wt. %, about 16 wt. %, about 17 wt. %, about 18 wt. %, about 19 wt. % or about 20 wt. %, based on the weight of the dry composition. The noble metal is, for example, present from about 10 g/ft³, about 15 g/ft³, about 20 g/ft³, about 40 g/ft³ or about 50 g/ft³ to about 70 g/ft³, about 90 g/ft³, about 100 g/ft³, about 120 g/ft³, about 130 g/ft³, about 140 g/ft³, about 150 g/ft³, about 160 g/ft³, about 170 g/ft³, about 180 g/ft³, about 190 g/ft³, about 200 g/ft³, about 210 g/ft³, about 220 g/ft³, about 230 g/ft³, about 240 g/ft³ or about 250 g/ft³, based on the volume of the three dimensional structure comprising the metal fiber felt.

The catalyst composition, in addition to the refractory metal oxide support and catalytically active metal, may further comprise any one or combinations of the oxides of lanthanum, barium, praseodymium, neodymium, samarium, strontium, calcium, magnesium, niobium, hafnium, gadolinium, terbium, dysprosium, erbium, ytterbium, manganese, iron, tin, zinc, nickel, cobalt or copper. Oxidation, LNT and three-way catalysts advantageously comprise a platinum group metal (PGM) dispersed on a refractory metal oxide support.

Functional catalyst and sorbent compositions may also comprise a sorbent useful for adsorbing hydrocarbons (HC) from the engine exhaust during startup of the vehicle when the catalyst is cold and unable to oxidize the hydrocarbons to CO₂ (cold start). When the temperature of the exhaust increases to the point when the platinum group metal in the catalyst becomes active, hydrocarbon is released from the sorbent and is subsequently oxidized to CO₂. Any known hydrocarbon storage material can be used, e.g., a microporous material such as a zeolite or zeolite-like material. In a preferred embodiment, the hydrocarbon storage material is a zeolite. The zeolite can be a natural or synthetic zeolite such as faujasite, chabazite, clinoptilolite, mordenite, silicalite, zeolite X, zeolite Y, ultrastable zeolite Y, ZSM-5 zeolite, offretite, or a beta zeolite. Preferred zeolite adsorbent materials have a high silica to alumina ratio. The zeolites may have a silica/alumina molar ratio (“SAR”) of from at least about 5:1, preferably at least about 50:1, with useful ranges of from about 5:1 to 1000:1, 50:1 to 500:1, as well as about 25:1 to 300:1. Preferred zeolites include ZSM, Y and beta zeolites. A particularly preferred adsorbent may comprises a beta zeolite of the type disclosed in U.S. Pat. No. 6,171,556 to Burk et al., which is incorporated herein by reference in its entirety.

SCR catalysts include, but are not limited to, base metal (e.g., copper and/or iron) ion-exchanged molecular sieves (e.g., Cu—Y and/or Fe-beta) or vanadia-based compositions such as, for example, V₂O₅/WO₃/TiO₂/SiO₂. Base metal ion-exchanged zeolites are described, for example, in U.S. Pat. No. 7,998,423 to Boorse et al., which is incorporated herein by reference. One exemplary SCR catalyst is CuCHA, for example copper-SSZ-13. Molecular sieves exhibiting structures similar to chabazite such as SAPO are also found effective. Thus, CuSAPO, for example copper-SAPO-34 is also suitable. Further suitable SCR compositions are also disclosed, for example, in U.S. Pat. No. 9,017,626 to Tang et al., U.S. Pat. No. 9,242,238 to Mohanan et al., and U.S. Pat. No. 9,352,307 to Stiebels et al., which are incorporated herein by reference. For example, such SCR compositions include compositions comprising a vanadia/titania catalyst and a Cu-zeolite or comprising a mixture of a Cu-containing molecular sieve and a Fe-containing molecular sieve.

Molecular sieves refer to materials having an extensive three-dimensional network of oxygen ions containing generally tetrahedral type sites and having a pore distribution of relatively uniform pore size. A zeolite is a specific example of a molecular sieve, further including silicon and aluminum. Reference to a “non-zeolite-support” or “non-zeolitic support” in a catalyst layer refers to a material that is not a zeolite and that receives precious metals, stabilizers, promoters, binders and the like through association, dispersion, impregnation or other suitable methods. Examples of such non-zeolitic supports include, but are not limited to, high surface area refractory metal oxides. High surface area refractory metal oxide supports can comprise an activated compound selected from the group consisting of alumina, zirconia, silica, titania, ceria, lanthana, baria and combinations thereof.

Useful molecular sieves incorporated into SCR catalysts, for instance, have 8-ring pore openings and double-six ring secondary building units, for example, those having the following structure types: AEI, AFT, AFX, CHA, EAB, ERI, KFI, LEV, SAS, SAT or SAV. Included are any and all isotopic framework materials such as SAPO, AlPO and MeAPO materials having the same structure type.

Aluminosilicate zeolite structures do not include phosphorus or other metals isomorphically substituted in the framework. That is, “aluminosilicate zeolite” excludes aluminophosphate materials such as SAPO, AlPO and MeAPO materials, while the broader term “zeolite” includes aluminosilicates and aluminophosphates.

The 8-ring small pore molecular sieves include aluminosilicates, borosilicates, gallosilicates, MeAPSOs and MeAPOs. These include, but are not limited to SSZ-13, SSZ-62, natural chabazite, zeolite K-G, Linde D, Linde R, LZ-218, LZ-235, LZ-236, ZK-14, SAPO-34, SAPO-44, SAPO-47, ZYT-6, CuSAPO-34, CuSAPO-44 and CuSAPO-47. In specific embodiments, the 8-ring small pore molecular sieve will have an aluminosilicate composition, such as SSZ-13 and SSZ-62.

In one or more embodiments, the 8-ring small pore molecular sieve has the CHA crystal structure and is selected from the group consisting of aluminosilicate zeolite having the CHA crystal structure, SAPO, AlPO, and MeAPO. In particular, the 8-ring small pore molecular sieve having the CHA crystal structure is an aluminosilicate zeolite having the CHA crystal structure. In a specific embodiment, the 8-ring small pore molecular sieve having the CHA crystal structure will have an aluminosilicate composition, such as SSZ-13 and SSZ-62. Copper- and iron-containing chabazite are termed CuCHA and FeCHA.

Molecular sieves can be zeolitic (zeolites) or may be non-zeolitic. Both zeolitic and non-zeolitic molecular sieves can have the chabazite crystal structure, which is also referred to as the CHA structure by the International Zeolite Association. Zeolitic chabazite includes a naturally occurring tectosilicate mineral of a zeolite group with approximate formula (Ca,Na₂,K₂,Mg)Al₂Si₄O₁₂.₆H₂O (i.e., hydrated calcium aluminum silicate). Three synthetic forms of zeolitic chabazite are described in “Zeolite Molecular Sieves,” by D. W. Breck, published in 1973 by John Wiley & Sons, which is hereby incorporated by reference. The three synthetic forms reported by Breck are Zeolite K-G, described in J. Chem. Soc., p. 2822 (1956), Barrer et. Al.; Zeolite D, described in British Patent No. 868,846 (1961); and Zeolite R, described in U.S. Pat. No. 3,030,181 to Milton, which are hereby incorporated by reference. Synthesis of another synthetic form of zeolitic chabazite, SSZ-13, is described in U.S. Pat. No. 4,544,538. Synthesis of a synthetic form of a non-zeolitic molecular sieve having the chabazite crystal structure, silicoaluminophosphate 34 (SAPO-34), is described in U.S. Pat. No. 4,440,871 to Lok et al. and U.S. Pat. No. 7,264,789 to Van Den et al., which are incorporated herein by reference. A method of making yet another synthetic non-zeolitic molecular sieve having chabazite structure, SAPO-44, is described, for instance, in U.S. Pat. No. 6,162,415 to Liu et al., which is incorporated herein by reference. Molecular sieves having a CHA structure may be prepared, for instance, according to methods disclosed in U.S. Pat. No. 4,544,538 to Zones and U.S. Pat. No. 6,709,644 to Zones et al., which are incorporated herein by reference.

A synthetic 8-ring small pore molecular sieve (for example, having the CHA structure) may be prepared via mixing a source of silica, a source of alumina and a structure directing agent under alkaline aqueous conditions. Typical silica sources include various types of fumed silica, precipitated silica and colloidal silica, as well as silicon alkoxides. Typical alumina sources include boehmites, pseudo-boehmites, aluminum hydroxides, aluminum salts such as aluminum sulfite or sodium aluminate and aluminum alkoxides. Sodium hydroxide is typically added to the reaction mixture. A typical structure directing agent for this synthesis is adamantyltrimethyl ammonium hydroxide, although other amines and/or quaternary ammonium salts may be substituted or added. The reaction mixture is heated in a pressure vessel with stirring to yield a crystalline product. Typical reaction temperatures are in the range of from about 100° C. to about 200° C., for instance from about 135° C. to about 170° C. Typical reaction times are between 1 hr and 30 days and in specific embodiments, for instance, from 10 hours to 3 days. At the conclusion of the reaction, optionally the pH is adjusted to between 6 and 10, for example between 7 and 7.5, and the product is filtered and washed with water. Any acid can be used for pH adjustment, for instance, nitric acid. Optionally, the product may be centrifuged. Organic additives may be used to help with the handling and isolation of the solid product. Spray-drying is an optional step in the processing of the product. The solid product is thermally treated in air or nitrogen. Alternatively, each gas treatment can be applied in various sequences or mixtures of gases can be applied. Typical calcination temperatures are in from about 400° C. to about 850° C.

The molecular sieves may have a SAR of from about 1, about 2, about 5, about 8, about 10, about 15, about 20 or about 25 to about 30, about 35, about 40, about 45, about 50, about 60, about 70, about 80 about 90, about 100, about 150, about 200, about 260, about 300, about 400, about 500, about 750 or about 1000. For instance, present molecular sieves may have a SAR of from about 5 to about 250, from about 10 to about 200, from about 2 to about 300, from about 5 to about 250, from about 10 to about 200, from about 10 to about 100, from about 10 to about 75, from about 10 to about 60, from about 10 to about 50, from about 15 to about 100, from about 15 to about 75, from about 15 to about 60, from about 15 to about 50, from about 20 to about 100, from about 20 to about 75, from about 20 to about 60 or from about 20 to about 50.

The present molecular sieves are, for example, copper- and/or iron-containing. The copper and/or iron resides in the ion-exchange sites of the molecular sieves and may also be associated with the molecular sieves but not “in” the pores. For example, upon calcination, non-exchanged copper salt decomposes to CuO, also referred to herein as “free copper” or “soluble copper.” Free base metal may be advantageous, as disclosed in U.S. Pat. No. 8,404,203 to Bull et al., which is incorporated herein by reference. The amount of free base metal such as copper may be less than, equal to or greater than the amount of ion-exchanged base metal.

Copper- or iron-containing molecular sieves are prepared, for example, via ion-exchange from, e.g., a Na⁺ containing molecular sieve (Na⁺ form). The Na⁺ form generally refers to the calcined form without any ion exchange. In this form, the molecular sieve generally contains a mixture of Na⁺ and H⁺ cations in the exchange sites. The fraction of sites occupied by Na⁺ cations varies depending on the specific zeolite batch and recipe. Optionally, the alkali metal molecular sieves are NH₄⁺-exchanged and the NH₄⁺ form is employed for ion-exchange with copper or iron. Optionally, the NH₄⁺-exchanged molecular sieve is calcined to the H⁺-exchanged form, which H⁺ form may be employed for ion-exchange with copper or iron ions. Copper or iron is ion-exchanged into molecular sieves with alkali metal, NH₄⁺ or H⁺ forms with copper or iron salts such as copper acetate, copper sulfate, iron chloride, iron acetate and the like, for example as disclosed in U.S. Pat. No. 9,242,238 to Mohanan et al., which is incorporated herein by reference. For instance, a Na⁺, NH₄⁺ or H⁺ form of a molecular sieve is mixed with an aqueous salt solution and agitated at an elevated temperature for a suitable time. The slurry is filtered and the filter cake is washed and dried.

In some embodiments, the molecular sieves may contain other catalytically active metals such as copper, iron, manganese, cobalt, nickel, cerium, platinum, palladium, rhodium or combinations thereof. Further, at least a portion of a catalytically active metal may be included during a molecular sieve synthetic process such that a tailored colloid contains a structure directing agent, a silica source, an alumina source and a metal ion (e.g., copper) source.

Where the molecular sieves contain one or more metals, the amount of such metal(s) can vary. For example, the amount of iron in an iron-containing molecular sieve is, for example, from about 1.0 to about 15 wt. % and the amount of copper in the copper-containing molecular sieve is for example from about 0.3 to about 10.0 wt. %, based on the total weight of the iron-containing molecular sieve. The amount of copper in a copper-containing molecular sieve is, e.g., about 0.2, about 0.3, about 0.4, about 0.5, about 0.6, about 0.7, about 0.8, about 0.9, about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9 or about 5.0 wt. %, based on the total weight of the copper-containing molecular sieve. The amount of iron in an iron-containing molecular sieve is, e.g., about 3.0, about 3.5, about 4.0, about 4.5, about 5.0, about 5.5, about 6.0, about 6.5, about 7.0, about 7.5, about 8.0, about 8.5, about 9.0, about 9.5 or about 10 wt. %, based on the total weight of the iron-containing molecular sieve. Amounts of catalytic metals like copper or iron in a molecular sieve are reported as the oxide, CuO or Fe₂O₃. The total dry weight of the molecular sieve includes any added/exchanged metals like copper or iron.

In general, 8-ring small pore molecular sieves containing copper or iron may each have a sodium content (reported as Na₂O on a volatile free basis) of below 2 wt. %, based on the total weight of the calcined molecular sieve. In more specific embodiments, sodium content is below 1 wt. % or below 2500 ppm. The molecular sieves may each have an atomic sodium to aluminum ratio of from about 0.02 to about 0.7. The molecular sieves may each have an atomic copper or iron to sodium ratio of from about 0.5 to about 50.

In some embodiments, alkali or alkaline earth metals may be incorporated into a copper-containing molecular sieve to provide additional SCR promotion. For example barium can be incorporated into a molecular sieve (e.g., CuCHA) by addition of Ba acetate before, after, or in a co-exchange process with Cu.

Copper- or iron-containing molecular sieves may exhibit a BET surface area, determined according to DIN 66131, of at least about 400 m²/g, at least about 550 m²/g or at least about 650 m²/g, for example from about 400 to about 750 m²/g or from about 500 to about 750 m²/g. The present molecular sieves may have a mean crystal size of from about 10 nanometers to about 10 microns, from about 50 nanometers to about 5 microns or from about 0.1 microns to about 0.5 microns as determined via SEM. For instance, the molecular sieve crystallites may have a crystal size greater than 0.1 microns or 1 micron and less than 5 microns.

The molecular sieves may be provided in the form of a powder or a spray-dried material is admixed with or coated with suitable modifiers. Modifiers include silica, alumina, titania, zirconia and refractory metal oxide binders (for example a zirconium precursor). The powder or the sprayed material, optionally after admixing or coating by suitable modifiers, may be formed into a slurry, for example with water, which is deposited upon a suitable substrate as disclosed for example in U.S. Pat. No. 8,404,203 to Bull et al., which is incorporated herein by reference.

When present on a substrate (i.e., a substrate comprising a metal fiber felt as outlined herein), SCR catalyst compositions are present at a concentration of, for instance, from about 0.3 g/in³ to 4.5 g/in³, or from about 0.4 g/in³, about 0.5 g/in³, about 0.6 g/in³, about 0.7 g/in³, about 0.8 g/in³, about 0.9 g/in³ or about 1.0 g/in³ to about 1.5 g/in³, about 2.0 g/in³, about 2.5 g/in³, about 3.0 g/in³, about 3.5 g/in³ or about 4.0 g/in³, based on the substrate. Concentration of a catalyst composition, or any other component, on a substrate refers to concentration per any one three dimensional section or zone, for instance, any cross-section of a substrate or of the entire substrate.

Coating layers of molecular sieves may be prepared using a binder, for example, a ZrO₂ binder derived from a suitable precursor such as zirconyl acetate or any other suitable zirconium precursor such as zirconyl nitrate. Zirconyl acetate binder provides a coating that remains homogeneous and intact after thermal aging, for example, when the catalyst is exposed to high temperatures of at least about 600° C., for example, about 800° C. and higher, and high water vapor environments of about 10% or more. Other potentially suitable binders include, but are not limited to, alumina and silica. Alumina binders include aluminum oxides, aluminum hydroxides, and aluminum oxyhydroxides. Aluminum salts and colloidal forms of alumina many also be used. Silica binders include various forms of SiO₂, including silicates and colloidal silica. Binder compositions may include any combination of zirconia, alumina, and silica.

LNT catalysts are taught, for instance, in U.S. Pat. No. 8,475,752 to Wan and U.S. Pat. No. 9,321,009 to Wan et al., which are incorporated herein by reference. LNT catalysts are believed to operate via promoting storage of NOx during a lean period of operation where the air to fuel ratio (λ) is greater than 1 (i.e. λ>1.0) and catalyze reduction of stored NOx to N₂ during a rich period where the air to fuel ratio (λ) is less than 1 (i.e. λ<1.0). Some LNT catalysts will release NOx above a specific temperature. This temperature is dependent upon the composition of the LNT washcoat.

LNT catalyst compositions typically comprise a NOx sorbent and a platinum group metal component dispersed on a refractory metal oxide support. The LNT catalyst composition may optionally contain other components such as oxygen storage components. One exemplary suitable NOx sorbent comprises a basic oxygenated compound of an alkaline earth element selected from magnesium, calcium, strontium, barium and mixtures thereof and/or an oxygenated compound of a rare earth component such as cerium (ceria component). The rare earth compound may further contain one or more of lanthanum, neodymium or praseodymium.

The present functional metal fiber felts may contain a sorbent useful for trapping and releasing, for example, NOx or sulfur compounds. Sorbents include, but are not limited to, materials such as alkaline earth metal oxides, alkaline earth metal carbonates, rare earth oxides, and molecular sieves. In addition, the present functional fiber felts may also comprise a sorbent useful for trapping and releasing hydrocarbons (HC). Sorbents include, but are not limited to, materials such as molecular sieves and zeolites.

AMOx catalysts are taught, for instance, in U.S. Pat. Appl. Pub. No. 2011/0271664 to Boorse et al., which is incorporated herein by reference. An ammonia oxidation (AMOx) catalyst may be a supported precious metal component which is effective to remove ammonia from an exhaust gas stream. The precious metal may include ruthenium, rhodium, iridium, palladium, platinum, silver or gold. The precious metal component may also include physical mixtures or chemical or atomically-doped combinations of precious metals. The precious metal component, for instance, includes platinum. Platinum may be present in an amount of from about 0.008% to about 2 wt. % based on the total weight of the AMOx catalyst.

The precious metal component of an AMOx catalyst is typically deposited on a high surface area refractory metal oxide support. Examples of suitable high surface area refractory metal oxides include alumina, silica, titania, ceria, and zirconia, as well as physical mixtures, chemical combinations and/or atomically-doped combinations thereof. In specific embodiments, the refractory metal oxide may contain a mixed oxide such as silica-alumina, amorphous or crystalline aluminosilicates, alumina-zirconia, alumina-lanthana, alumina-chromia, alumina-baria, alumina-ceria and the like. An exemplary refractory metal oxide comprises high surface area γ-alumina having a specific surface area of about 50 to about 300 m²/g. The AMOx catalyst may include a zeolitic or non-zeolitic molecular sieve, for example, selected from those of the CHA, FAU, BEA, MFI and MOR types. A molecular sieve may be physically mixed with an oxide-supported platinum component. In an alternative embodiment, platinum may be distributed on the external surface or in the channels, cavities or cages of the molecular sieve.

TWC catalyst compositions are disclosed, for instance, in U.S. Pat. No. 4,171,288 to Keith et al. and U.S. Pat. No. 8,815,189 to Arnold et al., which are incorporated herein by reference. TWC catalyst compositions comprise, for example, one or more platinum group metals disposed on a high surface area, refractory metal oxide support, e.g., a high surface area alumina. The refractory metal oxide supports may be stabilized against thermal degradation by materials such as zirconia, titania, alkaline earth metal oxides such as baria, calcia or strontia or, most usually, rare earth metal oxides, for example, ceria, lanthana and mixtures of two or more rare earth metal oxides. TWC catalysts can also be formulated to include an oxygen storage component.

The articles of this invention may comprise one or more catalyst compositions selected from a diesel oxidation catalyst (DOC), a lean NOx trap (LNT), a three-way catalyst (TWC), an ammonia oxidation catalyst (AMOx) and a selective catalytic reduction (SCR) catalyst. In some embodiments, the catalyst composition is substantially free of noble metals, e.g., substantially free of platinum group metals. “Substantially free” means for instance “little or no”, for instance, means “no intentionally added” and having only trace and/or inadvertent amounts. For instance, it means less than 2 wt. % (weight %), less than 1.5 wt. %, less than 1.0 wt. %, less than 0.5 wt. %, 0.25 wt. % or less than 0.01 wt. %, based on the weight of the indicated total composition.

The metal fiber felt substrates may advantageously have zoned coatings, that is, containing a catalyst coating with a certain function at the inlet end of the three dimensional fiber felt structure and a different catalyst coating with a different function at the outlet end. Zoned coatings may overlap. Any one coating may extend from the inlet end towards the outlet end (or from the outlet end toward the inlet end) about 10%, about 20%, about 30%, about 40%, about 50%, about 60%, about 70%, about 80% or about 90% of the axial length of the metal felt substrate. Any one coating may extend the entire axial length of the substrate.

Some advantages of the present invention are as follows. The disclosed functional articles generally are highly durable and resistant to loss of catalyst and/or sorbent. The disclosed functional articles generally exhibit good functional coating adhesion, which allows for the application of difficult-to-apply catalyst and/or sorbent compositions and good resistance to vibrations and shocks. The disclosed functional articles generally exhibit excellent catalytic and sorptive performance. The catalyst and/or sorbent application process (coating process) is generally easy and can be done with existing technologies. The disclosed functional articles generally exhibit enhanced backpressure performance. The disclosed functional articles generally can bear high loadings of functional compositions, for instance up to 2 times higher than is possible with traditional cordierite or metal foil supports. The functional articles generally exhibit good thermal conductivity. The functional composition, when coated onto an article as disclosed herein, is contacted by exhaust gas from two sides rather than from one side as with traditional functional coatings, which enables thicker coatings without diffusion limitations of the functional performance.

The above characteristics further allow for more compact functional articles with high activity. In particular, although not intending to be limited by theory, it is believed that the high thermal conductivity of the disclosed functional articles allows for the excellent low temperature (e.g. cold start) catalytic performance as the article will exhibit a faster heat-up rate.

Also disclosed is an exhaust gas treatment system comprising a functional article as disclosed herein. An exhaust gas treatment system contains more than one article, for instance, a DOC article and a SCR article. A system may also comprise one or more articles containing a reductant injector, a diesel oxidation catalyst (DOC), a lean NOx trap (LNT), a three way conversion (TWC) catalyst, a soot filter, and/or an ammonia oxidation catalyst (AMOx). A soot filter, where included, may be an uncatalyzed or a catalyzed (CSF) wall-flow filter. For instance, the present treatment system may comprise, from upstream to downstream—an article containing a DOC, a CSF, a urea injector, an SCR article and an article containing an AMOx catalyst. A lean NOx trap (LNT) may also optionally be included.

Present articles, systems and methods are suitable for treatment of exhaust gas streams from mobile emissions sources such as trucks and automobiles. Articles, systems and methods are also suitable for treatment of exhaust streams from stationary sources such as power plants. Ammonia is a typical reductant for SCR reactions for treating exhaust of stationary power plants while urea is the typical SCR reducing agent for treatment of exhaust of mobile emissions sources. The disclosed substrates, in particular, may be appropriately adapted for removal of noxious or toxic substances from indoor air, for treatment of emissions from stationary industrial processes, or for catalysis in chemical reaction processes.

“Noble metal components” refer to noble metals or compounds thereof, such as oxides. Noble metals are ruthenium, rhodium, palladium, silver, osmium, iridium, platinum and gold.

“Platinum group metal components” refer to platinum group metals or compounds thereof, for example oxides. Platinum group metals are ruthenium, rhodium, palladium, osmium, iridium and platinum.

Noble metal components and platinum group metal components also refer to any compound, complex, or the like which, upon calcinations or use thereof, decomposes or otherwise converts to a catalytically active form, usually the metal or the metal oxide.

Present articles are suitable for treatment of exhaust gas streams of internal combustion engines, for example gasoline, light-duty diesel and heavy duty diesel engines. The articles are also suitable for treatment of emissions from stationary industrial processes, removal of noxious or toxic substances from indoor air or for catalysis in chemical reaction processes.

The term “catalytic article” refers to an element that is used to promote a desired reaction.

The term “functional article” refers to an element that is used to promote a desired reaction and/or to provide a sorbent function.

The term “exhaust stream” or “exhaust gas stream” refers to any combination of flowing gas that may contain solid or liquid particulate matter. The stream comprises gaseous components which may contain certain non-gaseous components such as liquid droplets, solid particulates and the like. An exhaust stream of an internal combustion engine typically further comprises combustion products, products of incomplete combustion, oxides of nitrogen, combustible and/or carbonaceous particulate matter (soot) and un-reacted oxygen and/or nitrogen.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±5%, ±4%, ±3%, ±2%, ±1%, ±0.5%, ±0.4%, ±0.3%, ±0.2%, ±0.1% or ±0.05%. All numeric values are modified by the term “about” whether or not explicitly indicated. Numeric values modified by the term “about” include the specific identified value. For example “about 5.0” includes 5.0.

Unless otherwise indicated, all parts and percentages are by weight. Weight percent (wt. %), if not otherwise indicated, is based on an entire composition free of any volatiles, that is, based on dry solids content. All U.S. patent applications, published patent applications and patents referred to herein are hereby incorporated by reference.

Many modifications and other implementations of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific implementations disclosed, and that modifications and other implementations are intended to be included within the scope of the appended claims. Moreover, although the foregoing descriptions and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

### Experimental Section

### EXAMPLE 1

### DOC Comprising a Comparative Cordierite Substrate 1

Catalytic coatings are applied via a washcoat technique to a 1″ diameter by 3 inches long cordierite monolith core of 400 cpsi to provide a coating concentration of 3.5 g/in³ with 120 g/ft³ of a 1:1 weight ratio of Pt:Pd. In the catalytic powders that are used to prepare slurries for coating, Pt and Pd are supported on a commercially available gamma alumina. The catalytic powders are prepared via incipient wetness impregnation of the support materials with PGM precursors followed by drying and calcination at about 500° C. After coating the catalytic slurry, the core is dried and calcined at about 500° C.

### EXAMPLE 2

### DOC Comprising a Corrugated Metal Fiber Felt Substrate 1

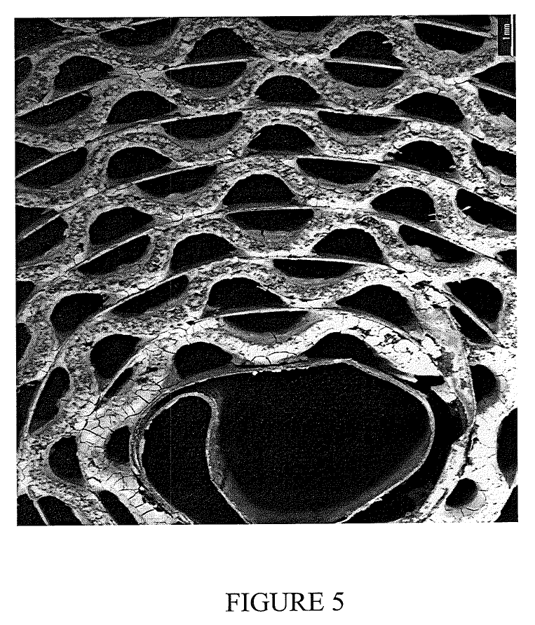

Identical coatings as Comparative Example 1 are applied to a 1 inch diameter by 2 inches long corrugated fibrous Fecralloy® core of 400 cpsi, applying the same total amount of the same catalyst compositions followed by drying and calcination. The fibrous metal felt is sponge-like, allowing for easy application of the washcoat slurry. FIG. 5 is a photograph of the inventive coated metal fiber felt. The catalyst composition in the inventive article is applied at a level of 5.2 g/in³. At this loading, the voids in the metal felt are filled with the catalytic composition so that no flow of gases occurs through the channel walls except via diffusion.

### EXAMPLE 3

### CO and HC Conversions in a Laboratory NEDC Test of DOC

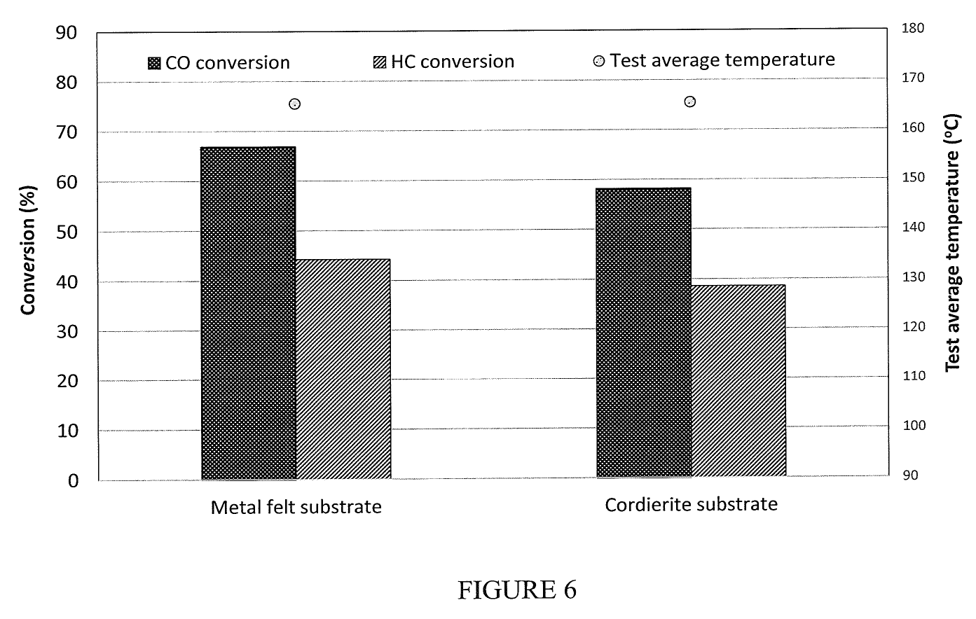

The catalytic articles of Examples 1 and 2 were engine-aged at 750° C. for 25 hours and tested using a laboratory version of the “New European Driving Cycle” (NEDC) test. Carbon monoxide (CO) and hydrocarbon (HC) conversion results are seen in FIG. 6. Both CO and HC conversions for the inventive article are higher than for the comparative catalyst with cordierite substrate, confirming the performance advantage of the inventive article.

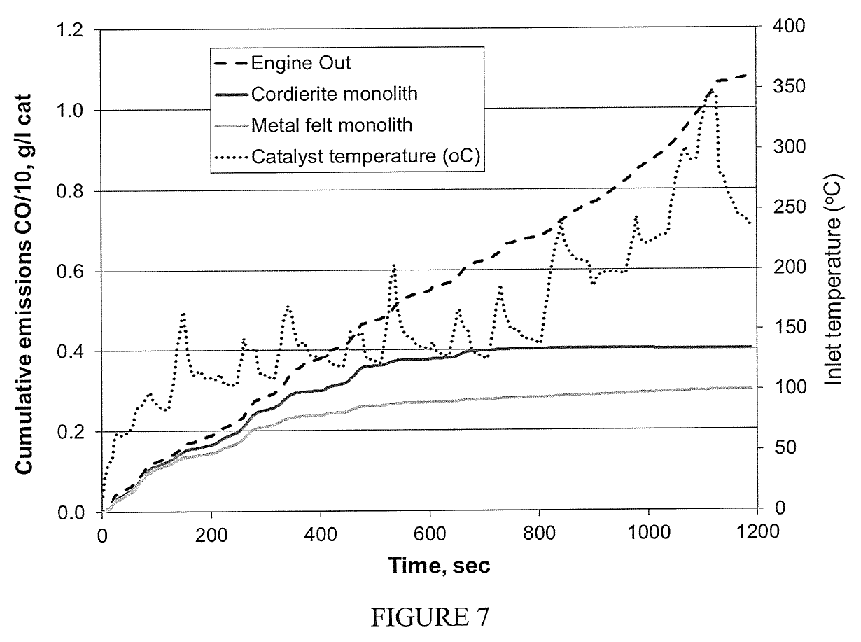

The performance advantage shown in FIG. 6 results from the better low temperature performance of the DOC on the metal felt substrate as seen from FIG. 7 (which provides a graph of tailpipe CO emissions over time in the laboratory transient catalytic performance test for the DOC catalyst on the Fechraloy® felt and commercial cordierite substrates). This improved low temperature performance is likely due to higher thermal conductivity—hence faster heatup—of the catalyst on the metal felt substrate compared to the reference on the cordierite substrate

### EXAMPLE 4

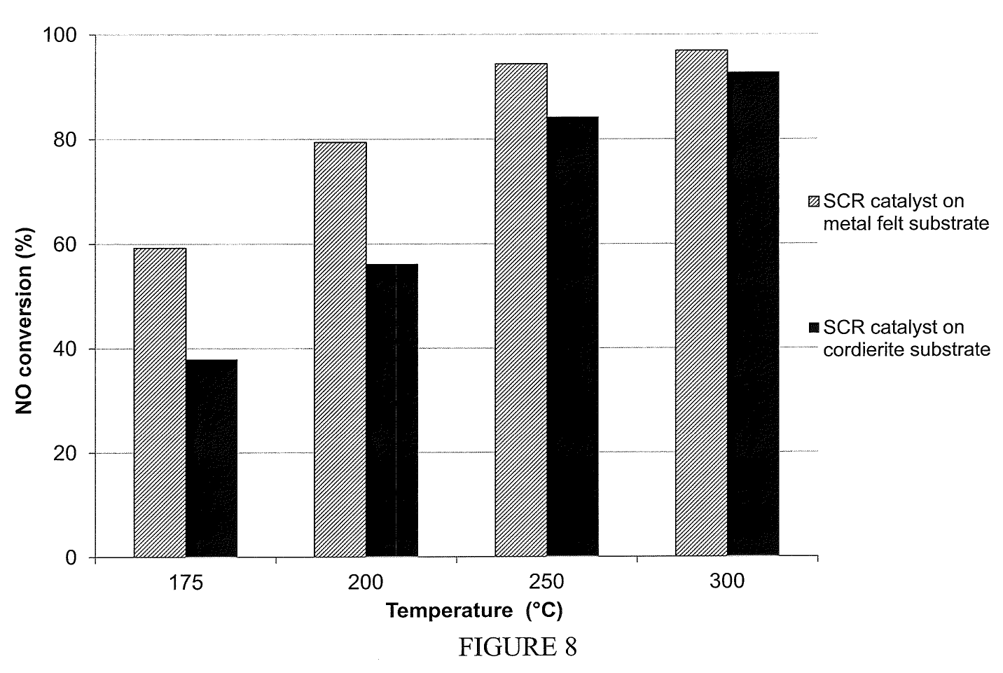

SCR Performance SCR catalysts were prepared by coating 3.5 g/inch³ of the catalytically active component on a 1″×3″ commercial cordierite monolith substrate of 400 cpsi and on a 1″×3″ corrugated Fechraloy® felt substrate of 400 cpsi, followed by drying and calcination. The catalysts were tested in a laboratory SCR performance test (SCR reaction: 6 NO+4 NH₃=5 N₂+6 H₂O) in the temperature interval 175-300° C., under test conditions of 500 ppm NO, 500 ppm NH₃, 5% H₂O, 10% O₂, balance N₂; GHSV=80 000 h⁻¹. The test results summarized in FIG. 8 demonstrate a substantial performance advantage of the sample on the Fechraloy® felt substrate.

### EXAMPLE 5

### LNT Performance

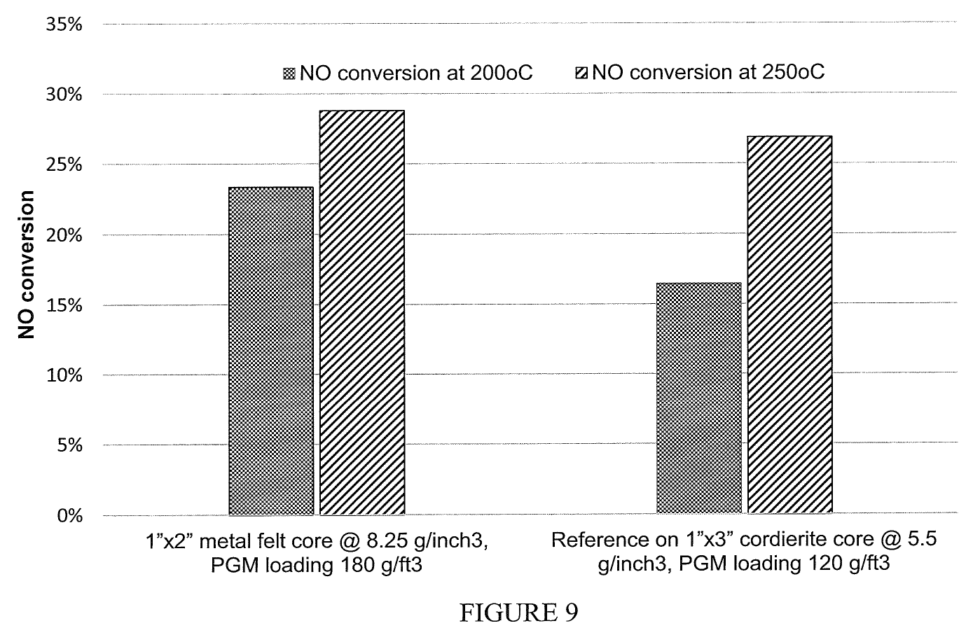

LNT (Lean NOx Trap) catalysts were prepared by coating 5.5 g/inch³ of the catalytically active component on a 1″×3″ cordierite monolith substrate of 400 cpsi, and 8.25 g/inch³ on a 1″×2″ corrugated Fechraloy® felt substrate of 400 cpsi, followed by drying and calcination. The catalytically active component contained 120 g/ft³ Pt and Pd on a proprietary support material. The catalysts were tested in a laboratory LNT performance test at 200° C. and 250° C. and GHSV=40 000 h⁻¹. The test consisted of alternating lean (285 sec. duration) and rich (8 sec. duration) pulses. Feed gas composition in the lean pulse consisted of 10% O₂, 5% CO₂, 5% H₂O, 200 ppm NO, balance N₂. Feed gas composition in the rich pulse consisted of 0.9% O₂, 5% CO₂, 5% H₂O, 2.48% CO, 0.74% H₂, 1500 ppm C₃H₆, balance N₂. The test results are represented in FIG. 9 as the average NO conversions in the lean plus rich cycle. As can be seen, the sample on the Fechraloy® felt substrate shows a performance advantage relative to the analog on the cordierite substrate.

### EXAMPLE 6

### DOC Comprising a Comparative Cordierite Substrate

A cordierite monolith substrate is coated with a DOC composition to provide a catalyst loading of 4.3 g/in³ on 400 cpsi substrates that are 5.66 inch in diameter by 3 inch long.

### EXAMPLE 7

### DOC Comprising a Corrugated Metal Fiber Felt Substrate

An inventive metal fiber felt substrate is coated with a DOC composition at the same catalyst loading of 4.3 g/in³ on 400 cpsi substrates that are 5.66 inch in diameter by 3 inch long.

### EXAMPLE 6

### Backpressure Test

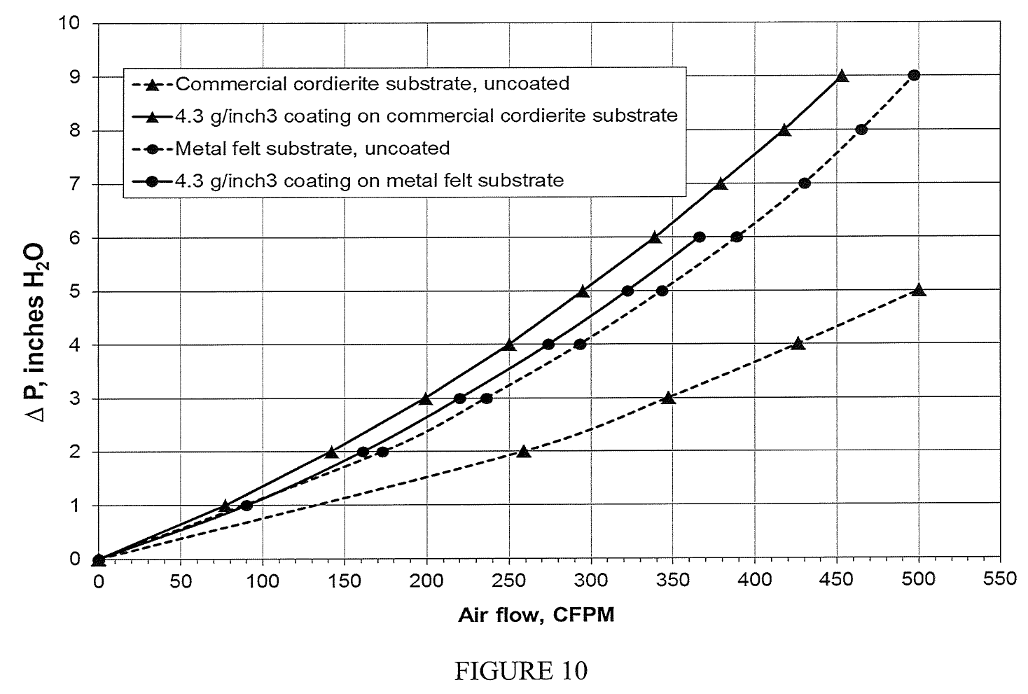

Pressure drop for uncoated Fechraloy® felt and commercial cordierite honeycomb substrates of 400 cpsi, 5.66 inch diameter by 3 inch long was measured. The articles of Examples 6 and 7 were then tested for back-pressure performance. Results are seen in FIG. 10. As can be seen, the uncoated Fechraloy® felt substrate has higher ΔP compared to the cordierite substrate. However, coating of the cordierite substrate resulted in a substantial increase of the back-pressure, while only a minor increase was registered for the coated Fechraloy® felt substrate. The resulting pressure drop for the coated DOC on the coated Fechraloy® felt substrate is ˜10% lower than for the catalyst on the cordierite substrate. This is due to the fact that the washcoat on the cordierite substrate is deposited on the channel walls, which makes the channels more narrow, while with the metal felt substrate, the washcoat penetrates the highly porous walls, which does not decrease the cross-section of the channels.

1. A functional article comprising:
a metal fiber felt, the metal fiber felt having an array of metal fibers and voids; and
a functional composition, comprising a catalyst composition, a sorbent composition, or both a catalyst composition and a sorbent composition disposed on the metal fibers and within the voids.

2. The functional article of claim 1, wherein the functional composition comprises a catalyst composition.

3. The functional article of claim 1, wherein the functional composition comprises a sorbent composition.

4. The functional article of claim 1, wherein the metal fiber felt is woven.

5. The functional article of claim 1, wherein the metal fiber felt is non-woven.

6. The functional article of claim 1, wherein the metal fiber felt is flat.

7. The functional article of claim 1, wherein the metal felt is corrugated.

8. The functional article of claim 1, comprising a three-dimensional matrix comprising a plurality of metal fiber felt layers.

9. The functional article of claim 8, wherein the three-dimensional matrix comprises both corrugated layers of the metal fiber felt and flat layers of the metal fiber felt.

10. The functional article of claim 8, wherein the three-dimensional matrix comprises corrugated layers of the metal fiber felt and flat layers of a metal foil.

11. The functional article of claim 8, wherein the three-dimensional matrix comprises corrugated layers of a metal foil and flat layers of the metal fiber felt.

12. The functional article of claim 10, wherein the metal fiber felt comprises the functional composition as a coating within the voids.

13. The functional article of claim 10, wherein the metal foil comprises the functional composition as a coating thereon.

14. The functional article of claim 8, further comprising a metal jacket with the three-dimensional matrix in an interior portion thereof.

15. The functional article of claim 1, wherein the metal fiber felt comprises stainless steel, nickel, a NiCr alloy or a FeCr alloy.

16. The functional article of claim 1, wherein the metal fiber felt comprises a FeCrAl alloy.

17. The functional article of claim 1, wherein the metal fiber felt has a void volume of from about 20% to about 95% or about 60% to about 90%, based on the total volume of the metal felt.

18. The functional article of claim 1, wherein the functional composition occupies from about 5% to about 100% or about 30% to about 100% of an original void volume of the metal fiber felt substrate that exists before coating with the functional composition.

19. The functional article of claim 1, wherein the metal fiber felt is from about 50 μm to about 12,000 μm or about 100 μm to about 500 μm thick on average.

20. The functional article of claim 1, wherein the metal fiber felt contains metal fibers having an average diameter of from about 1 μm to about 250 μm or about 10 μm to about 100 μm.

21. The functional article of claim 1, wherein the functional composition comprises from about 2% to about 80% or about 20% to about 60% of the total weight of the metal felt plus the functional composition.

22. The functional article of claim 1, wherein the catalyst composition comprises a platinum group metal or a base metal.

23. The functional article of claim 1, wherein the catalyst composition comprises a DOC (diesel oxidation catalyst), a LNT (lean NOx trap), a TWC (three-way catalyst), an AMOx (ammonia oxidation) catalyst, an SCR (selective catalytic reduction) catalyst, or any combination thereof.

24. An exhaust gas treatment system comprising the functional article of claim 1.

25. A method for treating an exhaust gas stream, comprising passing the exhaust gas stream through the functional article of claim 1.

26. A system comprising the functional article of claim 1 for the removal of noxious or toxic substances from indoor air, for treatment of emissions from stationary industrial processes, or for catalysis in chemical reaction processes.
